(19) United States
(12) Patent Application Publication
(10) Pub. No.: US 2008/0178506 A1
(43) Pub. Date: Jul. 31, 2008

(54) SIGN SYSTEM ADAPTOR

(76) Inventor: Benjamin L. Garfinkle, Piedmont, CA (US)

Correspondence Address: DERGOSITS & NOAH LLP, Suite 1450, Four Embarcadero Center, San Francisco, CA, 94111, US

(21) Appl. No.: 12/057,127

(22) Filed: Mar. 27, 2008

Related U.S. Application Data
(63) Continuation-in-part of application No. 10/147,669, filed on Jul. 22, 2002.
Application No. 10/147,669 is a division of application No. 09/684,726, filed on Oct. 6, 2000, now Pat. No. 6,530,166.

(51) Int. Cl. G09F 7/18

(52) U.S. Cl. 40/658

(57) ABSTRACT

A sign holder device in the form of individual parts which, upon assembly, provides for support and display of signage. The sign holder device is in the form of a base or stem configured to receive and support a sign frame, the base or stem including a C-shaped extremity. An adaptor is provided having a lower region sized to engage and be frictionally retained by the C-shaped extremity and an upper region sized to receive and frictionally retain the sign frame which otherwise would not properly seat and be frictionally maintained by the C-shaped extremity.

### RELATED APPLICATIONS

The present application is a continuation-in-part of U.S. application Ser. No. 10/147,669 filed on Jul. 22, 2002, which is a divisional of U.S. Pat. No. 6,530,166, issued on Mar. 11, 2003.

### TECHNICAL FIELD

The present invention is directed to a sign holder device in the form of individual parts which, upon assembly, provides for the support and display of signage in a plurality of orientations. By employing devices as taught herein, a retail facility can inventory a bin of parts and construct signage of a variety of configurations and orientations avoiding the need to stockpile signs of fixed geometry. An adaptor is provided which enables a wide variety of sign frames to be used with various holder devices thus expanding the scope of devices disclosed in the previously filed related applications.

### BACKGROUND OF THE INVENTION

Retail establishments such as supermarket chains require signage of every imaginable configuration. Every product sold requires some type of sign to inform a consumer of the nature and price of products on display. For example, produce such as oranges, bananas and grapefruit require one type of signage while frozen food bins and deli cases yet others. It is impractical for a multi-product retail establishment such as a grocery chain to inventory preassembled signage for each dedicated orientation. A far better solution is to provide the retailer with an inventory of parts which can be assembled on site depending upon the product display requiring such signage.

The present invention is a not the first instance in which it was suggested that retail store signage be provided from a parts bin rather than as assembled members. However, prior knockdown component oriented kits have not been universally embraced by the retail trade for several reasons. Prior art products of this nature tend to be flimsy, and not easily assembled and disassembled and oftentimes require a certain level of skill and experience in converting the bin of parts to professionally looking customer-inviting signage. For example, it is oftentimes important to position a sign frame appropriately upon a support stem in order to make the sign support professional looking. However, retail store employees are called upon to work quickly moving from one location to the next and it is oftentimes incumbent upon them to assemble and disassemble signage rapidly. Kit products of the prior art, when assembled rapidly by non-skilled personnel, tend to look haphazard and not professional in construction.

It is also important to retailers to be able to construct signage from a bin of parts. Flexibility is achieved as multiple signage is constructed by picking and choosing individual components enabling a wide variety of such products to be fabricated on site.

It is thus an object of the present invention to provide a sign holder device in the form of individual parts which, when assembled, provides for a professional appearing support for the display of signage in a plurality of orientations.

This and further objects will be more readily apparent when considering the following disclosure and appended claims.

### SUMMARY OF THE INVENTION

A sign holder device comprised of individual parts which, upon assembly, provides for support and display of signage, the sign holder device comprising a base or stem configured to receive and support a sign frame, said base or stem including a C-shaped extremity, the improvement comprising an adaptor having an upper region and lower region, said lower region sized to be frictionally retained and seated within C-shaped extremity and said upper region being sized to frictionally retain and maintain said sign frame in instances in which said sign frame would not properly seat and be frictionally maintained by C-shaped extremity.

### BRIEF DESCRIPTION OF THE FIGURES

FIG. 1 is a perspective view of an assembled sign frame of the prior art illustrating the environment in which the present invention can be employed.

FIG. 2 is an exploded side view showing the joining of frame and stem members of FIG. 1 employing the adaptor of the present invention.

FIGS. 3A-3D are side views of various adaptors useful in practicing the present invention.

### DETAILED DESCRIPTION OF THE INVENTION

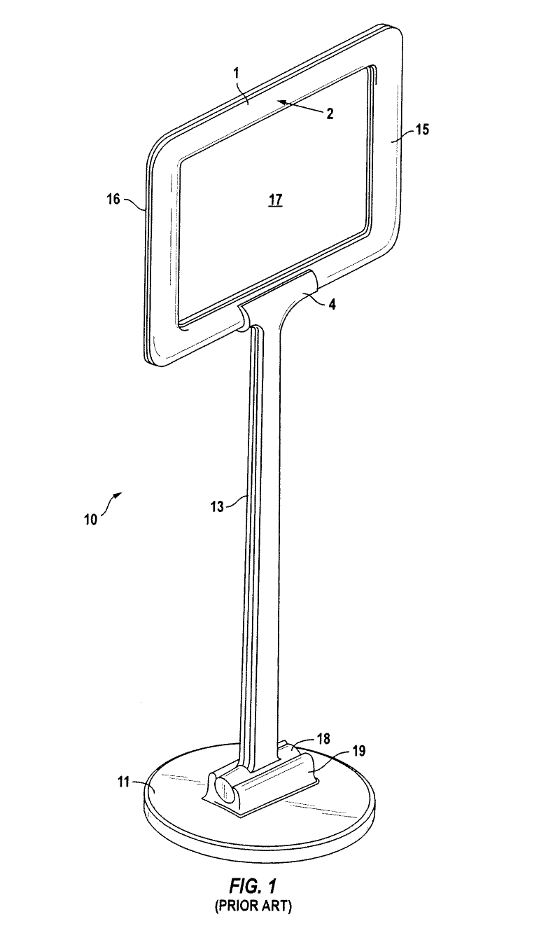

FIG. 1 depicts a sign holder device described in applicant's U.S. Pat. No. 6,530,166, the disclosure of which is incorporated by reference herein. This sign holder device is shown in which the various individual parts have been joined. Sign holder device 10 is shown constructed of base 11, stem 13 and frame halves 15 and 16, each of which are capable of rapid disassembly and reassembly on site.

The base employed to support the remaining parts of the sign holder device can be of several different configurations depending upon the surrounding structure used to support it. When the sign holder device is intended to be placed upon a flat horizontal surface such as that of a table or counter, base 11 is most appropriate.

Base 11 can include a C-shaped receiving element 19 which is sized to frictionally retain cylindrical portion 18 of stem 9 as shown or frame halves 15 and 16 if stem 13 is eliminated. Frame halves 15 and 16 are sized to create open region 17 which is intended to accept signage slid between the frame halves as needed.

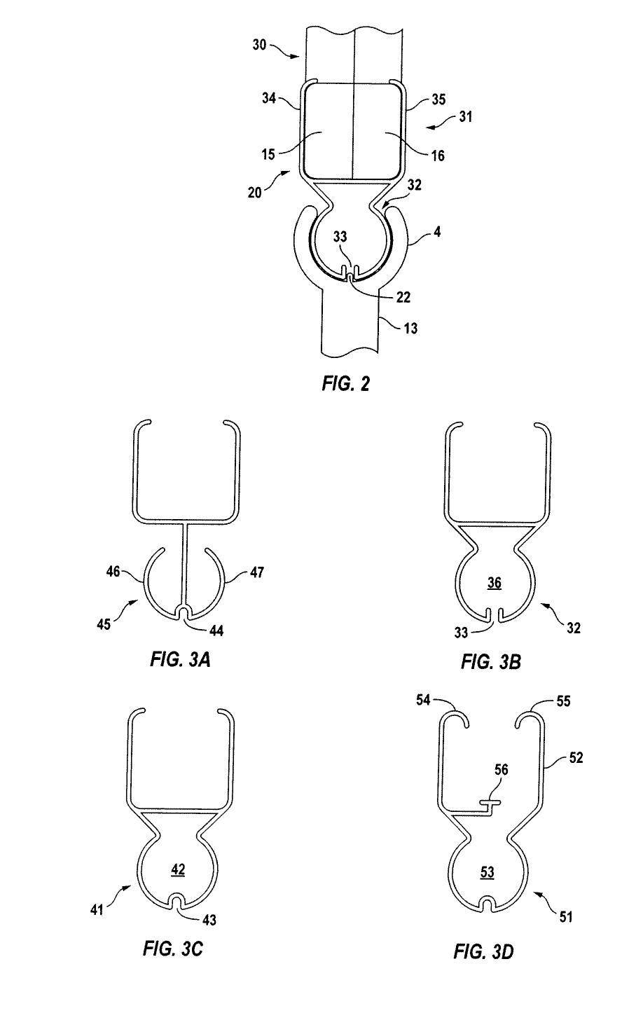

Most frames are composed of frame halves 15 and 16 and when snap fit together are separated from one another by shoulders (not shown) creating a gap. Ridge 22 (FIG. 2) can be caused to pass within and be captured by the gap as C-shaped member 4 frictionally captures the outer surface of frame halves 15 and 16. Frames can also be extruded or molded as a single section without being composed of joined halves.

Although the invention described and claimed in applicant's U.S. Pat. No. 6,530,166 operates well when dealing with frame halves 15 and 16 which, when snapped fit together, are separated from one another by shoulders creating a gap, it is recognized that oftentimes frames whether composed of frame halves or of a unitary construction, do not provide such a gap. If stem 13 of FIG. 2, being provided with ridge 22 engages frame 30 not having a gap, frame 30 will not properly fit within stem 13 and C-shaped member 4 will fail to adequately frictionally capture the outer surface of frame 30. Thus, the present adaptor can be used with frames, stems and bases made by others who may not produce frames with gaps but which could benefit from the signage concept proposed herein. In addition, the present adaptor can be used even when the associated base or stem is devoid of a ridge. Frictional capture between parts is a viable use of this invention.

In providing a sign holder device which is universally capable of capturing signs 30 without gaps, adaptor 20 is provided. Specifically, adaptor 20 is characterized as having upper region 31 and lower region 32. Lower region 32 is sized to frictionally fit within stem 13 (or receiving element 19 of base 11) being captured by C-shaped member 4. It is noted that lower region 32 is also characterized as having indent 33 sized and positioned to receive ridge 22. Between the frictional fit of the outer surface of lower region 32 and the inner surface of C-shaped member 4 (or 19) together with the coupling of ridge 22 and indent 33, adaptor 20 is well secured within stem 13 (or base 11).

In summary, in the embodiment shown in FIG. 2, sign frame 30 is shown being received by upper region 31 of adaptor 20. The frame does not present a gap. As such, if frame 30 was to be seated directly within C-shaped member 4 of stem 13 or member 19 of base 11, the shape of C-shaped member 4 of stem 13 or of member 19 of base 11 would prevent appropriate seating of the frame therein. However, by employing adaptor 20, frame 30 is frictionally captured between adaptor capture arms 34 and 35. Through the use of the present adaptor, one can now employ any one of many possible sign holder devices with a myriad of sign frames whether or not those sign frames can be directly captured within the sign holder devices as previously discussed.

It should further be noted that the adaptor useful in practicing the present invention can take on a myriad of configurations, many of which are dictated by fabrication options. As illustrations of such possible options, reference is made to FIG. 3.

In turning to FIG. 3, FIG. 3B illustrates the adaptor shown, for illustrative purposes, in FIG. 2. An alternative for this adaptor is shown in FIGS. 3A and 3C. The difference between the adaptor of FIG. 3B and FIG. 3C is that indent 33 (FIG. 3B) creates an open region 36 as indent 33 is comprised of two upturned legs as extensions from the side walls of lower region 32. By contrast, lower region 41 (FIG. 3C) is in the form of a closed area 42 as indent 43 closes region 42 from the exterior of the adaptor of FIG. 3C. FIG. 3A depicts an adaptor in which lower region 45 is composed of two upturned legs 46 and 47 so that the entire lower region 45 is opened even though indent 44 is created as the equivalent to indents 33 and 43 of FIGS. 3B and 3C, respectively.

The adaptor of FIG. 3D differs in some regards with respect to the adaptors of FIGS. 3A, 3B and 3C. Specifically, lower region 51 and upper region 52 are completely open with regard to one another while lower region 51 is similar to lower region 41 (FIG. 3C) creating closed region 53. Further, upper region 52 is composed of capture arms 54 and 55 having severally turned in legs, as shown, thus capturing frame halves of more narrow dimension. In doing so, in order to further stabilize these frame halves within the adaptor of FIG. 3D, protrusion 56 is established to either reside within any gap which may exist between the frame halves or at least frictionally contact the seam line between frame halves.

Globally, from an even cursory review of the possible adaptor configurations shown in FIGS. 3A through 3D, it should be apparent that the present adaptor can be made in a multitude of configurations, each of which enabling a frame, whether a gap exists or not to be captured by a suitable sign holder device.

Although the present invention has been described in regard to the example of FIG. 1 which is a sign holder device intended to be placed upon a flat horizontal surface such as that of a table or a counter, many other configurations can be employed while remaining within the spirit and scope of this invention.

As noted previously, the present application has incorporated by reference, the disclosure of applicant's previously issued U.S. Pat. No. 6,530,166. In that disclosure, other sign holder devices were described and, again, each of them can be employed with the present adaptor for carrying out the present invention. For example, a base intended to reside upon a series of parallel wires is one such possible configuration. Another involves a base intended to fit between parallel wooden slats. Further, the frame can be used with a base while eliminating a stem. Thus, frame 30 can be used with base 11 by employing the present adaptor between these elements.

It has also been recognized that quite frequently receiving members such as C-shaped member 4 (or 19) are of a size or geometry which prevents them from appropriately receiving a sign frame because the sign frame border is of a size or geometry which does not lend itself to appropriate frictional connection. Ideally, sign frame 30 should frictionally seat within any appropriate receiving member to enable it to assume and maintain an appropriate orientation to enable signage contained therein to be visible to a consumer while not seating so tightly that its removable would be difficult recognizing that the thrust of the present invention is to provide a kit of parts which can be readily assembled and disassembled on site. In this regard, an appropriate frictional fit is established when one can grasp stem 13 or base 11 while applying lateral force in the direction of arrow 2 against border region 1 (FIG. 1) resulting in the sign frame being released from the appropriate C-shaped receiving element.

In carrying out the objects recited in the previous paragraph, the present invention further embraces an adaptor which can be frictionally supported by a C-shaped extremity on a base or stem and which has an upper region which can frictionally retain a sign frame which otherwise because of its size or geometry would not appropriately fit within the subject C-shaped extremity.

While various embodiments of the present invention have been shown and described, other modifications thereof are possible within the scope of the following claims.

1. A sign holder device comprised of individual parts which, upon assembly, provides for support and display of signage, the sign holder device comprising a base or stem configured to receive and support a sign frame, said base or stem including a C-shaped extremity, the improvement comprising an adaptor having an upper region and lower region, said lower region sized to be frictionally retained and seated within C-shaped extremity and said upper region being sized to frictionally retain and maintain said sign frame in instances in which said sign frame would not properly seat and be frictionally maintained by C-shaped extremity.

2. The sign frame holder device of claim 1 wherein said C-shaped extremity is provided with a ridge and the lower region of said adaptor is provided with an indent sized and positioned to receive said ridge when captured by said C-shaped extremity.

3. The sign holder device of claim 2 wherein said sign frame is devoid of any gap that would be sized and positioned to receive said ridge preventing said sign frame from being frictionally received by said C-shaped extremity without use of said adaptor.

4. A sign holder device comprised of individual parts which, upon assembly, provides for support and display of signage, the sign holder device comprising a base or stem configured to receive and support a sign frame, said base or stem having C-shaped extremity, a sign frame having an open region and a border region defining said open region, said border region being of a size or shape preventing it from being received and supported by C-shaped extremity and an adaptor having a lower region sized to engage and be frictionally retained by said C-shaped extremity and an upper region sized to receive and frictionally retain said sign frame.

5. The sign holder device of claim 4 wherein said sign frame is frictionally retained by said adaptor to the extent that said sign frame is maintained in an orientation to enable a sign contained therein to be visible to a consumer but which is removable from said adaptor by applying lateral force thereto causing said sign frame to unseat from said upper region of said adaptor.
